(19) United States
(12) Patent Application Publication
(10) Pub. No.: US 2004/0164148 A1
(43) Pub. Date: Aug. 26, 2004

(54) System and method for identifying an object

(76) Inventor: Guanghua Qiu, Collegeville, PA (US)

Correspondence Address: Andrew L. Ney, 4 Andorra Hill, Lafayette Hill, PA, 19444, US

(21) Appl. No.: 10/754,965

(22) Filed: Jan. 9, 2004

Related U.S. Application Data
(60) Provisional application No. 60/439,482, filed on Jan. 13, 2003.
(60) Provisional application No. 60/442,714, filed on Jan. 27, 2003.

(51) Int. Cl. G06K 15/00

(52) U.S. Cl. 235/383

(57) ABSTRACT

An object identification system and method that eliminates accessing a lookup data base, such as a reference service provider or an object naming service provider, to learn the address of the appropriate information service provider that has the information pertinent to the object that is of interest to the user. By including in the code with which an object is marked the address of that information service provider where the information pertinent to the object is stored, that information service provider can be accessed directly by the user to extract the information pertinent to the object without the need to learn the address of the appropriate information service provider via, for example, a reference service provider or an object naming service provider.

### RELATED APPLICATIONS

This application is the non-provisional application of Provisional Application 60/439,482 filed Jan. 13, 2003 and Provisional Application 60/442,714 filed Jan. 27, 2003.

### FIELD OF THE INVENTION

The present invention relates, in general, to identifying and tracking objects and, in particular, to a system and a method that enable users to promptly access and retrieve pertinent information of globally and uniquely identifiable objects.

### BACKGROUND OF THE INVENTION

Many objects, such as computer chips, computers, office furniture and equipment, hospital diagnostic and therapeutic units, documents, armaments, packages, shoes, and the like are tagged, for example, by an identification code, so that they can be identified and tracked and pertinent information about the objects, stored in an information service provider, can be retrieved, either manually or automatically. Various identification schemes, such as the Universal Product Code (UPC), Vehicle Identification Numbers, International Standard Book Numbers, and Electronic Product Code (EPC), currently are used to mark objects with an identification code. One of the most successful identification schemes is the UPC.

Referring to FIG. 1, which illustrates a first object identification system according to the prior art, when a UPC marked tag 104 is used for the identification of an object 102, a barcode scanner 106, attached to a computing system 108, such as a server or a desktop computer, scans the data of the tag and delivers the data to the computing system. If the computing system requests pertinent information about object 102 from a remote information service provider 118, such a request represented by an arrow 117, the address of the information service provider, established according to international standards, must be obtained. To obtain this address, a request is made by computing system 108 to a reference service provider 110. For a proprietary implementation (e.g., using Intranet 112), protocol reference service provider 110 can be a database or hard coded mapping that provides the capability for searching for the remotely located information service provider 118 based on the UPC code. For a public service application (e.g., using Internet 114), protocol reference service provider 110 can be a public directory service that provides the mapping service (i.e., mapping the UPC code into an Internet protocol address. An arrow 119 represents the transmission of the requested pertinent information from information service provider 118 to computing system 108.

Referring to FIG. 2, which illustrates a second object identification system according to the prior art, when an EPC marked tag 204 is used for the identification of an object 202, an RFID reader 206, attached to a computing system 208, such as a server or a desktop computer, reads the data of the tag and delivers the data to the computing system. If the computing system requests pertinent information about object 202 from a remote information service provider 218, such request represented by an arrow 217, the address of the information service provider must be obtained. To obtain this address, a request is made by computing system 208 to an object naming service provider 210. The object naming service maps the EPC code to an address. By using product markup language, the pertinent object information can be retrieved from information service provider 218 through either Intranet 212 or Internet 214. An arrow 219 represents the transmission of the pertinent information from information service provider 218 to computing system 208.

In general, the prior art requires a lookup of the address of the designated information service provider. The lookup is typically solution-specific or proprietary.

A UPC code is created using a 12-digit numeric sequence scheme. A UPC code essentially provides two separate numbers: one is a manufacturer identifier and one is an object model number. A series of light and dark lines on the tag or label represent the UPC code, while a human readable numeric equivalent is provided together with a standard symbol. UPC code typically is used as an identifier of the type of object rather than as an identifier of a single object item. Many variant barcodes have been adapted by different users for different applications.

Radio frequency identification (RFID), as a promising tagging technology, has advanced significantly in the recent past. An RFID tag holds rich information compared to a tag having a UPC code. More importantly, an RFID tag can be both read and written.

The data capability of RFID tags is increasing unceasingly in terms of data volume, reading, and writing/rewriting, while the cost of RFID tags continues to drop. It is expected that the price of an RFID tag will drop into the range of a few cents in the next few years and that paper thin RFID tags and the use of small and relatively inexpensive RFID readers, with the capability for wider reading ranges and faster data processing, will become reality.

The data capacity of an RFID tag creates an opportunity of labeling almost any single object item in the world which makes possible a tagged object uniquely identifiable and capable of being tracked almost anywhere.

The EPC, as an emerging technique, is created using a 96-bit numbering scheme for RFID applications. By taking advantage of the increased data capacity of an RFID transponder, namely an RFID tag, an EPC code utilizes three separate numbers: one is a manufacturer identifier, one is a product type identifier of the manufacturer, and one is an item serial number of a given product type. The EPC makes possible the unique identification of almost any single object anywhere in the world.

The advances of networking and Internet technologies have brought the world into an information era. The information of an object can be accessible almost anywhere and anytime using a software application (e.g., a web application) provided the location of the object information service server and access privileges are given. As indicated by the descriptions given above of the two prior art identification systems, mapping the identification of the object into the information service provider location, by current practices, is difficult. It is done using proprietary mechanisms in an application (e.g., hard coded mapping, directory service, database searching, object naming service), resulting in tremendous efforts in software development, deployment, training and maintenance. Even when done, the corresponding application is of poor interoperability, scalability, and capability of integration. The prior art practices also severely limit the use of service because a designated software application or time-consuming Internet surfing/searching is required for users.

In a business environment, if a user possesses a product and wants to retrieve some useful information pertinent to the product, the user might have to search the web site of the manufacturer or use the identification number that is input manually or automatically to locate the pertinent information through a specific software application that directs the request of the user to a designated and known information service server. At home, if a user wants to access, for example, a refrigerator owners manual if the original hard copy is lost, the user must contact the manufacturer to order a new manual or search the Internet. Clearly, any proprietary software required for home use makes no sense. For the most part, the process of getting information according to the prior art is time-consuming and not convenient. In the very near future, once home networks become popular, the information silos in business can be integrated and the world becomes the e-world where almost any single object in the world can be identified and tracked through the networks, the prior art practices will fall short in delivering satisfactory services.

Therefore, there is a need for a system and method to promptly access and retrieve the pertinent information of a globally and uniquely identifiable object through commonly and publicly used hardware and software.

### SUMMARY OF THE INVENTION

In an object identification system, constructed in accordance with the present invention, (a) information identifying an object, and (b) other information pertinent to the object is stored at a first location. The object is marked with a code that includes (a) the address of the first location, and (b) the information identifying the object. With the object at a second location, the code is extracted from the object while the object is at the second location. The code is transmitted from the second location to the first location and, in response to the code transmitted from the second location, the other information pertinent to the object is accessed at the first location and retrieved from the first location and is transmitted from the first location and received at the second location.

### BRIEF DESCRIPTION OF THE DRAWINGS

FIG. 1 illustrates a first object identification system constructed in accordance with the prior art in which an object has an UPC marked tag.

FIG. 2 illustrates a second object identification system constructed in accordance with the prior art in which an object has an EPC marked tag.

FIG. 3 illustrates an object identification system constructed in accordance with the present invention.

FIG. 4 illustrates “read/write” scenarios for an RFID reader.

FIG. 5 illustrates home applications of the present invention.

### DETAILED DESCRIPTION OF THE INVENTION

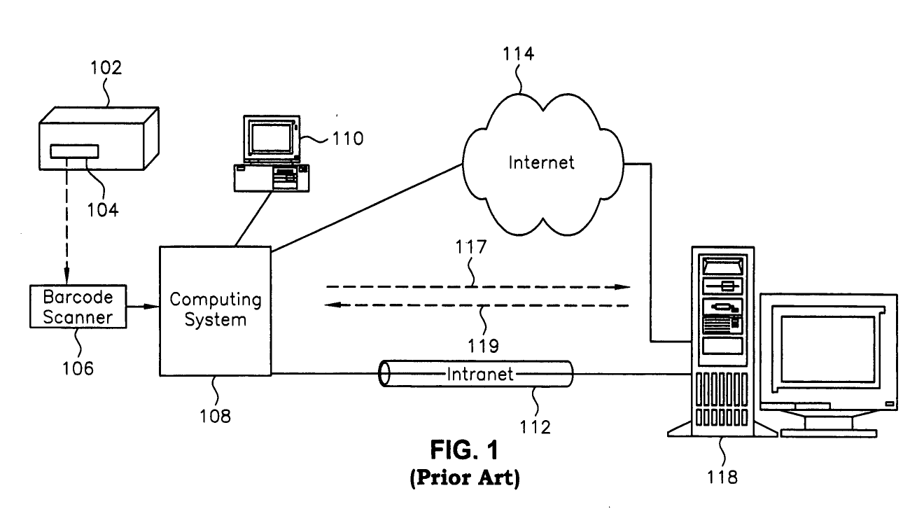

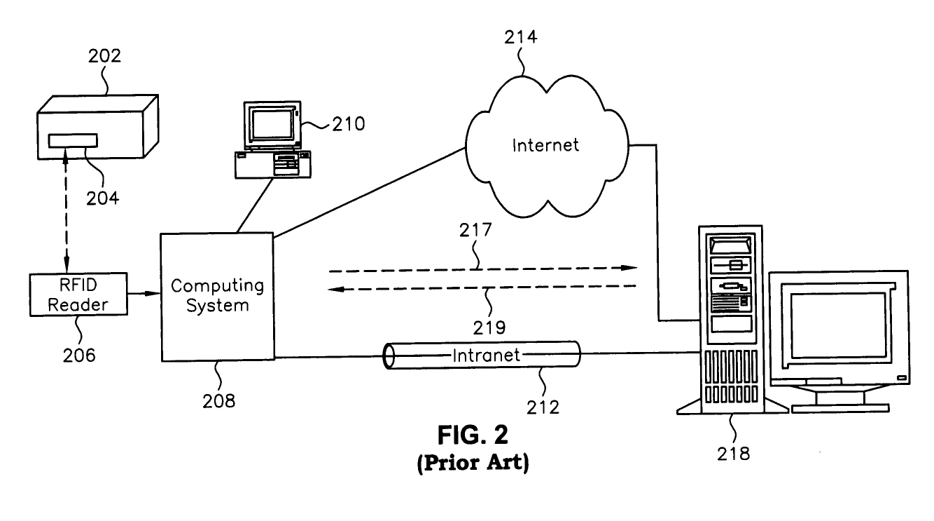

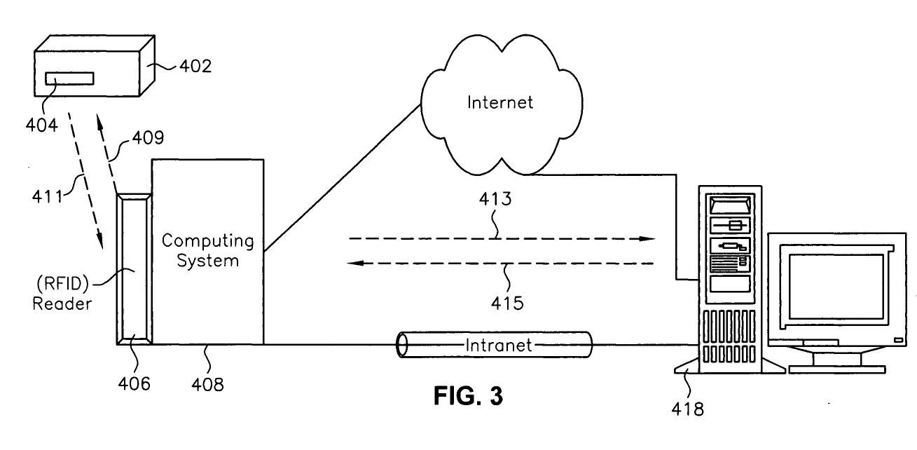

A comparison of FIG. 1 with FIG. 3 and a comparison of FIG. 2 with FIG. 3 reveals that the present invention, illustrated in FIG. 3, eliminates the need to access a reference service provider, such as the one identified by reference numeral 110 in FIG. 1, or an object naming service provider, such as the one identified by reference numeral 210 in FIG. 2, to learn the address of the appropriate information service provider that has the information pertinent to the object and is of interest to the user. By including in the code with which an object is marked the address of that information service provider where the information pertinent to the object is stored, that information service provider can be accessed directly by the user to extract the information pertinent to the object without the need to learn the address of the appropriate information service provider via, for example, a hard coded mapping, a protocol reference service provider, or an object naming service provider.

Referring to FIG. 3, an object identification system, constructed in accordance with the present invention, includes means for storing at a first location having an address (a) information identifying an object, and (b) other information pertinent to the object. For the embodiment of the invention being described, such means include an information service provider 418, such as a web server or database of conventional construction and operation, which stores information is the usual manner. The address of information service provider 418 preferably is established in accordance with international standards, currently, for example, IP Version 4 or 6, either in digital or symbolic form, but can also be a network card identification number or a computer host name.

An object identification system, constructed in accordance with the present invention, also includes a tag attached to an object at a second location and marked with a code that includes (a) the address of the first location, and (b) the information identifying the object. For the embodiment of the invention being described, an object 402 is tagged with an RFID transponder 404 of conventional construction and operation. RFID transponder 404 can be read-only (write once) or readable/rewriteable. The marking of object 402 with a code also can be with a tag having a bar code or the object can be marked with the code directly, for example, by stenciling.

As indicated above, UPC and EPC are codes in common use at the present time. Both UPC and EPC can be used in the present invention.

An UPC is created using a 12-digit numeric sequence scheme. A series of light and dark lines are used to represent a UPC code, while a human readable numeric equivalent is given together with a standard symbol. An example of an UPC is:

0.03456.89234.6

| | | | |
|---|---|---|---|
| Numbering System | Enterprise ID | Product Number. | Modulo Check |
| Character. | Number. | | Character. |

Examples of a code using UPC according to the present invention are:

0.IP.03456.89234.6

| | | | | |
|---|---|---|---|---|
| Numbering | Internet | Enterprise | Product | Modulo |
| System | Protocol | ID | Number. | Check |
| Character. | Address. | Number. | | Character. |
| | | OR | | |

0.03456.IP.89234.6

| | | | | |
|---|---|---|---|---|
| Numbering | Enterprise | Internet | Product | Modulo |
| System | ID | Protocol | Number. | Check |
| Character. | Number. | Address. | | Character. |

An EPC is created using a 96-digit numbering scheme. It includes an 8-bit header and three data partitions. An example of an EPC is:

02.0006A66.56271F.0003476AB
8 bits.28 bits.24 bits.36 bits

| | | | |
|---|---|---|---|
| Header. | Enterprise. | Product. | Serial Number. |

Examples of a code using EPC according to the present invention are:

02.IP.0006A66.56271F.0003476AB.XXx
8 bits.IP.28 bits.24 bits.36 bits.finite bits

| | | | | | |
|---|---|---|---|---|---|
| Header. | Internet Protocol | Enterprise. | Product. | Serial Number. | Other |
| | Address. | | | | Parameters |

02.0006A66.56271F.0003476AB.IP.XXx
8 bits.28 bits.24 bits.36 bits.IP.finite bits

| | | | | | |
|---|---|---|---|---|---|
| Header. | Enterprise. | Product. | Serial Number. | Internet Protocol | Other |
| | | | | Address | Parameters |

The code of the address of the information service provider can be in a first code group that is separate and distinct from a second code group having the code of the information identifying the object, or the code of the address of the information service provider can be shuffled with the code of the information identifying the object. The code groups in the first example given above of a code using UPC according to the present invention and the code groups in the first example given above of a code using EPC according to the present invention are arranged as separate and distinct code groups. The code groups in the second example given above of a code using UPC according to the present invention and the code groups in the second example given above of a code using EPC according to the present invention are shuffled. The address code group can be spilt into two or more parts for more complex shuffling for encryption purposes.

With object 402 at a second location remote from information service provider 418, the code in RFID transponder 404 is extracted by an RFID reader 406 of conventional construction and operation. This RFID reader, for example, can be part of a computing system 408 such as a desktop keyboard, a personal data assistant, a cellular phone, or a plug-and-play device, each of conventional construction and operation. As indicated above, the portion of the code corresponding to the address of the first location and the portion of the code corresponding to the information identifying the object can be separate and distinct code grouping or can be shuffled according to prescribed coding programs. The code is extracted from RFID transponder 404 according to a program that contemplates the program by which the object has been marked with the code. Arrows 409 and 411 represent, respectively, the reading of the code in RFID transponder 404 and the receiving of the code information by RFID reader 406. Arrow 409 also represents writing a new code into transponder 404 of changing the code is desired.

An object identification system, constructed in accordance with the present invention, further includes means for transmitting the code from the second location, namely RFID reader 406, to the first location, namely information service provider 418. For th embodiment of the invention being described, an application (e.g., Internet browser, terminal service, or specific software) with a software module included in computing system 408 that recognizes Internet protocol addresses parses the information in the code corresponding to the address of the first location, namely information service provider 418, held in and read from RFID transponder 402 and requests the pertinent information (e.g., package, product, or specification) from information service provider 418 if an Internet protocol is available and the network (Intranet 410 or Internet 414) is on. The transmission from RFID reader 406 to information service provider 418 is represented by an arrow 413.

An object identification system, constructed in accordance with the present invention, also includes means for accessing at the first location and retrieving from the first location, in response to the code transmitted from the second location, the other information pertinent to the object. Information service provider 418, of conventional construction and operation, is accessed and information stored in the information service provider is retrieved in the usual manner.

An object identification system, constructed in accordance with the present invention, also includes means for transmitting from the first location, namely information service provider 418, the other information pertinent to the object accessed at the first location and retrieved from the first location. The information service provider 418 returns the requested information. This is represented by an arrow 415.

An object identification system, constructed in accordance with the present invention, also includes means for receiving at the second location, namely at computing system 408, the other information pertinent to the object accessed at the first location and retrieved from the first location. The returned information can be either displayed or further processed to meet the needs of the user requesting this information. Although proprietary standards to facilitate the communications can be developed, the enabled Internet technology (e.g., non-proprietary and internationally standardized communication protocols, messaging schemes, and data processing mechanisms) preferably are used.

Object 402 can be marked with two or more addresses corresponding to two or more information service providers. For example, in certain applications, the pertinent information that a user wishes to access is not in an information service provider associated with the manufacturer identified on the object but rather in an information service provider associated with an unidentified subcontractor of the manufacturer identified on the object. With the addresses of both the manufacturer identified on the object and the unidentified subcontractor included in the code, when the information service provider associated with the manufacturer is accessed, the request for the pertinent information is transmitted to the information service provider associated with the subcontractor. After the pertinent information is retrieved from the information service provider associated with the unidentified subcontractor, it is transmitted to the user by way of the information service provider associated with the manufacturer identified on the object. The additional address(es) can be incorporated, for example, in the “Other Parameters” portion of the examples of the EPC codes given above.

As the RFID technology advances, RFID readers are becoming smaller and less expensive. To have desktop computers and other devices that are used daily capable of accessing the pertinent information of the object at reduced costs for both hardware and software, an RFID reader can be designed and manufactured as part of or an option for computer peripherals similar to a wireless card that is integrated into a computer mouse. A keyboard and a mouse can be arranged with the addition of an RFID reader. Although it might make more sense to have an RFID reader integrated with a mouse or a keyboard because of the convenience, same interface, and improved mobility, an RFID reader can be part of other computer peripherals, such as a scanner, fax machine, telephone, printer, and microphone. An RFID reader can also be designed and manufactured as part of an option of or an option for micro-computing devices, such as a cellular phone, personal data assistant, or other computing device.

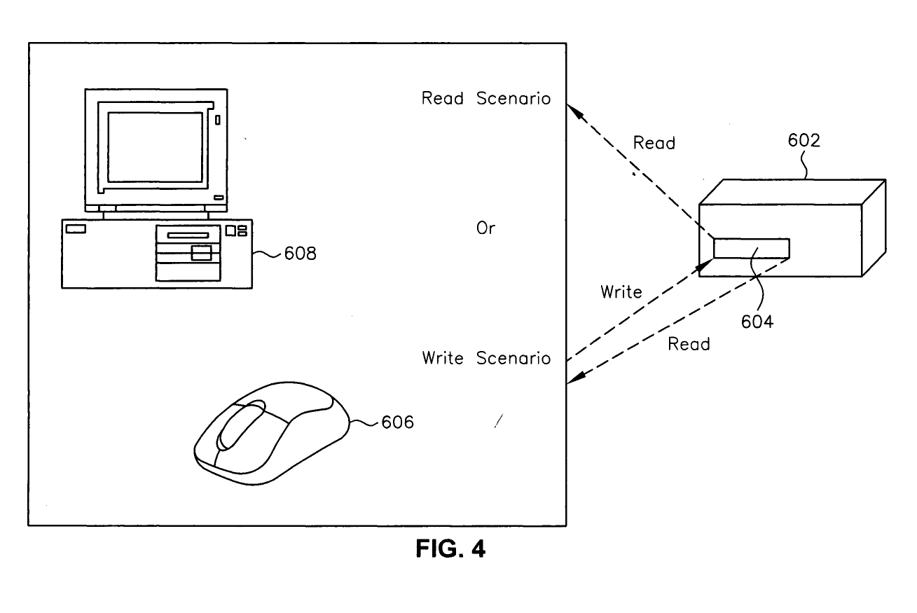

Referring to FIG. 4, in one embodiment of an attachable RFID reader on a computer mouse 606, a special button can be added in the mouse that can communicate with a computing system 608 either in a wired or wireless arrangement. The button trigger makes a high priority interrupt that operates only when an RFID reader is attached. The read data is delivered to computing system 608. A software driver receives the data and conveys it to an application such as a browser. Operational scenarios for mouse 606 can be: (1) “read” triggered by a button or the application, and (2) “write” triggered by the application that includes the two steps of first “write” and second “read” for confirmation.

In yet another implementation of a “read” scenario, a software component can be inserted into a standard Internet browser. A corresponding standard button can be added into the browser. The retrieval of the pertinent information of the tagged object 602 can be done simply by clicking the standard button as the tag 604 is within the access range of mouse 606.

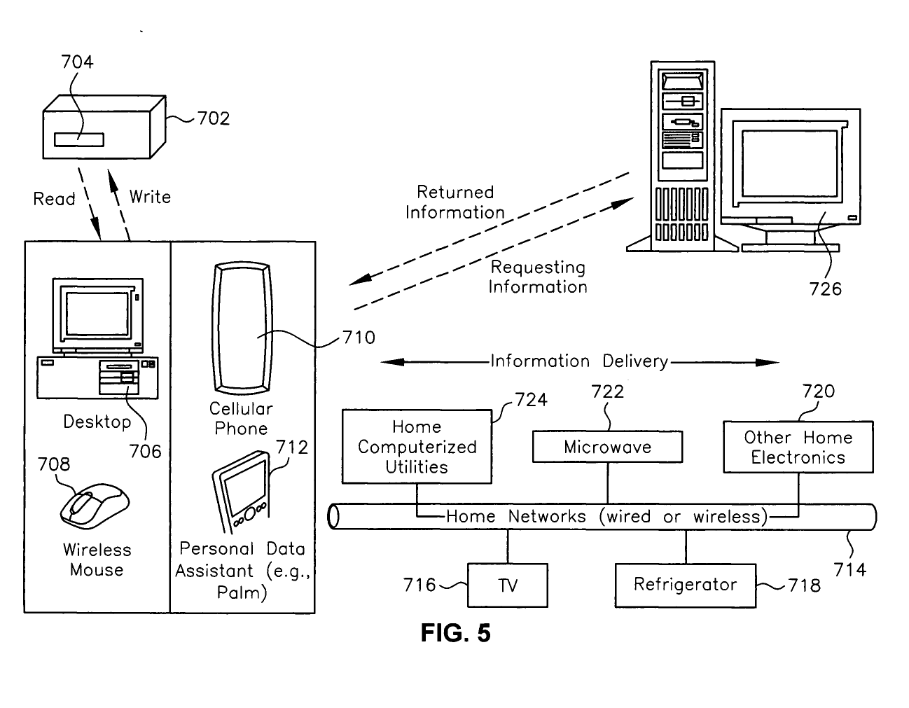

In the very near future, home networks, identified in FIG. 5 by reference numeral 714, that wired or wireless will have home electronic appliances able to communicate with each other. FIG. 5 shows a typical service model of the present invention implemented in a home. In one application, a user has a television set 716 and wishes to have it rewired with a video/audio system but the operational manual has been lost. The user uses a wireless RFID capable mouse 708 to read the code on a tag 704 on object 702 (television set 716 in this example). The operational manual appears on the screen of a desktop computer 706.

In another application, the user has a refrigerator 718 and has received a notice from the manufacturer of the refrigerator that the user can upgrade the software of the refrigerator to reduce energy consumption significantly. The user uses mouse 708 to read tag 704 on object 702 (refrigerator 718 in this example). The software upgrade component is downloaded automatically from a service provider 726 of the refrigerator manufacturer located remote from the user and delivered and installed in the refrigerator. When the software upgrade is completed, a new version number can be written back into the code marked in tag 704.

In another application, object 702 is a prepaid game card that has a tag 704 having a code that includes information about the user's identification and password, selections, data encryption codes and other information, such as a second address of a second information service provider. The user uses mouse 708 to read the code marked on tag 704 and a game program is downloaded automatically from service provider 726 that checks all of the submitted information and delivers service only when the submitted information passes the check. The game program then is installed automatically onto the game player of the user identified as other home electronics 720.

A cellular phone 710 or a personal data assistant 712 can be used to read/write a code on tag 704 and services can be delivered to a variety of other home electronics units, such a a microwave 722, home computerized utilities 724 and other home electronics 720.

It will be apparent that the applications of the present invention are virtually limitless in terms of the various objects that can be identified and about which pertinent information, stored at locations remote from the objects, can be accessed and retrieved. Furthermore, the applications of the present invention are not limited to identifying physical inanimate objects. Human beings, animals, and other living things, as well as logic objects such as software, also can be identified and tracked by the present invention.

While the present invention has been described in connection with the illustrated embodiments, it will be appreciated that modifications may be made in the details within the scope and range of equivalents of the claims without departing from the true spirit and scope of the present invention.

What is claimed:

1. An object identification method comprising the steps of:
storing at a first location having an address (a) information identifying an object, and (b) other information pertinent to the object;
marking the object with a code that includes (a) the address of the first location, and (b) the information identifying the object;
placing the object at a second location;
extracting the code from the object while the object is at the second location;
transmitting the code from the second location to the first location;
accessing at the first location and retrieving from the first location, in response to the code transmitted from the second location, the other information pertinent to the object;
transmitting from the first location the other information pertinent to the object accessed at the first location and retrieved from the first location; and
receiving at the second location the other information pertinent to the object accessed at the first location and retrieved from the first location.

2. An object identification method according to claim 1 wherein the code marked on the object is a finite alphabetic number.

3. An object identification method according to claim 2 wherein the code of the address of the first location is in a first code group and the code of the information identifying the object is in a second code group that is separate and distinct from the first group.

4. An object identification method according to claim 2 wherein the code of the address of the first location is shuffled with the code of the information identifying the object.

5. An object identification method according to claim 2 wherein the portion of the code corresponding to the information identifying the object is UPC.

6. An object identification method according to claim 2 wherein the portion of the code corresponding to the information identifying the object is EPC.

7. A method for accessing and retrieving information stored at a first location pertinent to an object that is at a second location and has been marked with a code that includes (a) an address of the first location, and (b) information identifying the object, the method comprising the steps of:
extracting the code from the object while the object is at the second location;
transmitting the code from the second location to the first location (a) to access at the first location and retrieve from the first location, in response to the code transmitted from the second location, the information pertinent to the object, and (b) transmit from the first location the information pertinent to the object accessed at the first location and retrieved from the first location; and
receiving at the second location the information pertinent to the object accessed at the first location and retrieved from the first location.

8. A method for accessing and retrieving information according to claim 7 wherein the code marked on the object is a finite alphabetic number.

9. An object identification method according to claim 8 wherein the code of the address of the first location is in a first code group and the code of the information identifying the object is in a second code group that is separate and distinct from the first group.

10. An object identification method according to claim 8 wherein the code of the address of the first location is shuffled with the code of the information identifying the object.

11. An object identification method according to claim 8 wherein the portion of the code corresponding to the information identifying the object is UPC.

12. An object identification method according to claim 8 wherein the portion of the code corresponding to the information identifying the object is EPC.

13. A method for enabling accessing and retrieving information stored at a first location pertinent to an object from a second location, the method comprising the steps of:
storing at the first location information (a) identifying an object, and (b) other information pertinent to the object;
marking the object with a code that includes (a) an address of the first location, and (b) the information identifying the object; and
placing the object at the second location.

14. A method for enabling accessing and retrieving information according to claim 13 wherein the code marked on the object is a finite alphabetic number.

15. A method for enabling accessing and retrieving information according to claim 14 wherein the code of the address of the first location is in a first code group and the code of the information identifying the object is in a second code group that is separate and distinct from the first group.

17. A method for enabling accessing and retrieving information according to claim 14 wherein the portion of the code corresponding to the information identifying the object is UPC.

18. A method for enabling accessing and retrieving information according to claim 14 wherein the portion of the code corresponding to the information identifying the object is EPC.

19. An object identification system comprising:
means for storing at a first location having an address (a) information identifying an object, and (b) other information pertinent to the object;
a tag attached to an object at a second location and marked with a code that includes (a) the address of the first location, and (b) the information identifying the object;
means for extracting the code from said tag;
means for transmitting the code extracted from said tag from the second location to the first location;
means for accessing at the first location and retrieving from the first location, in response to the code transmitted from the second location, the other information pertinent to the object;
means for transmitting from the first location the other information pertinent to the object accessed at the first location and retrieved from the first location; and
means for receiving at the second location the other information pertinent to the object accessed at the first location and retrieved from the first location.

20. An object identification system according to claim 19 wherein said tag is a bar code tag.

21. An object identification system according to claim 19 wherein said tag is an RFID transponder.

22. A system for enabling access and retrieval of information stored at a first location pertinent to an object from a second location, the system comprising:
means for storing at the first location information (a) identifying an object, and (b) other information pertinent to the object; and
a tag attached to the object at the second location and marked with a code that includes (a) the address of the first location, and (b) the information identifying the object.

23. A system for enabling access and retrieval of information according to claim 22 wherein said tag is a bar code tag.

24. A system for enabling access and retrieval of information according to claim 22 wherein said tag is an RFID transponder.

25. A code with which an object is marked and by which:
(a) the object, and
(b) the address of an information service provider, remote from the object and containing pertinent information about the object is stored, are identified, said code comprising:
a first code group containing an identification of the address of the information service provider; and
a second code group containing an identification of the object.

26. A code according to claim 25 wherein the first code group is separate and distinct from the second code group.

27. A code according to claim 25 wherein the first code group is shuffled with the second code group.

28. A code according to claim 25 wherein the second code group is UPC.

29. A code according to claim 25 wherein the second code group is EPC.

30. A code according to claim 25 further including a third code group containing information relating to the formats and organizations of the first code group and the second code group.

31. A code according to claim 30 further including a fourth code group containing selected information about the object.

32. A code according to claim 25 wherein the first code group is a network card identification number.

33. A code according to claim 25 wherein the first code group is a computer host name.

34. A code according to claim 25 wherein the first code group is a digital Internet Protocol address.

35. A code according to claim 25 wherein the first code group is a symbolic Internet Protocol address.
